(19) United States
(12) Patent Application Publication
(10) Pub. No.: US 2015/0348148 A1
(43) Pub. Date: Dec. 3, 2015

(54) GUIDED PROCUREMENT SYSTEM AND METHOD

(71) Applicants: SACHIN SHARMA, MUMBAI (IN); PRASAD GUPTE, MUMBAI (IN)

(72) Inventors: SACHIN SHARMA, MUMBAI (IN); PRASAD GUPTE, MUMBAI (IN)

(21) Appl. No.: 14/797,971

(22) Filed: Jul. 13, 2015

Related U.S. Application Data
(63) Continuation-in-part of application No. 13/739,977, filed on Jan. 11, 2013, now abandoned.

(30) Foreign Application Priority Data
Oct. 5, 2012 (IN) 2923/MUM/2012

(51) Int. Cl. G06Q 30/06

(52) U.S. Cl. CPC G06Q 30/0605

(57) ABSTRACT

A guided procurement system for guiding the buyer for procuring when the item to be purchased is not present in the catalog database, which is an integration of a procurement tool, supplier information system tool and supplier performance system tool. The system includes a processor unit and a computer readable medium storing instructions executable by the processor unit, including a first procurement guiding module that is adapted for guiding the requester for procurement when the item is not available in the catalog database, and a second procurement guiding module that is adapted for guiding the procurement team or the buyer for procurement from the right supplier. The system is adapted for guiding the buyer while procuring by suggesting the source of procurement based on the user provided information on a web form. It further guides by suggesting the supplier from which a particular item can be procured.

### CROSS-REFERENCE TO RELATED APPLICATION

The instant application is a continuation in part of U.S. patent application Ser. No. 13/739,977, filed Jan. 11, 2013, pending, and claims priority to Indian Patent Application Serial No. 2923/MUM/2012, filed Oct. 5, 2012, pending, the entire specifications of both of which are expressly incorporated herein by reference.

### FIELD OF THE INVENTION

The present invention relates generally to electronic procurement, and more particularly, to a system and method for guiding the buyer for procurement, for example, when the item is not present in the catalog database.

### BACKGROUND OF THE INVENTION

In the electronic procurement context, it is a routine practice of searching for an item in a catalog (e.g., an online catalog) while attempting to procure various items. However, there is no conventional system and/or method that can provide information for an item that is not present in the catalog.

Accordingly, there exists a need for new and improved electronic procurement systems and methods for providing information for items that are not present in the catalog that overcome at least one of the aforementioned problems.

### SUMMARY OF THE INVENTION

In accordance with the general teachings of the present invention, a system and a method are provided for guiding the buyer during a procurement process, for example an electronic procurement process, when the item is not present in the catalog, for example, an online catalog database.

More specifically, the system and method is adapted for guiding the buyer while procuring, for example, by suggesting the source of procurement based on the user provided information on a web-based form. Additionally, the system and method is also adapted for guiding the buyer while procuring by suggesting the supplier from which a particular item can be procured.

In accordance with one embodiment of the present invention, there is provided a guided procurement system for guiding the buyer for procuring when the item to be purchased is not present in the catalog database. In accordance with one aspect of this embodiment, the system includes an integration of a procurement tool, a supplier information system tool, and a supplier performance system tool.

In accordance with another embodiment of the present invention, the system includes:

a processor unit; and

a computer readable medium storing instructions executable by the processor unit, including:

a first procurement guiding module that is adapted for guiding the requester for procurement when the item is not available in the catalog database; and

a second procurement guiding module that is adapted for guiding the procurement team or the buyer for procurement from the right supplier.

By way of a non-limiting example, the system and method of the present invention guides the buyer during the procurement process by suggesting the source of procurement based on the user provided information on a web-based form. By way of a non-limiting example, the system and method of the present invention further guides the buyer during the procurement process by suggesting the supplier from which a particular item can be procured.

An object of the present invention is to provide a system and method for guiding the buyer during the procurement process, for example, when the item is not present in the catalog database.

Another object of the present invention is to provide a system and method for guiding the buyer during the procurement process by suggesting the source of procurement based on the user provided information on web-based form.

Yet another object of the present invention is to provide a system and method for guiding the buyer during the procurement process by suggesting the supplier from which a particular item can be procured.

In accordance with one embodiment of the present invention, there is provided a system for a guided procurement, wherein there is an interconnection of at least one configurable and namable business process element, comprising:

a host computer system;

at least one database component operably associated with the host computer system;

a communication interface for accessing the host computer system from a plurality of remote input/output devices to manage guided procurement, wherein the business process element includes:

a system for permitting a user to provide a free text input description of an item to be purchased on the input/output device;

a first guiding system operable to guide the user, when no items are found in a catalog database, to a guiding link or button and then generate a guided web-based form based at least upon one or more pre-configured decision rules;

wherein the first guiding system adapted for inputting information of one or more key fields on the guided web-based form, mapping the key fields input with one or more fields present in a transaction database, suggesting matched transaction fields to the key fields and providing the user an option to retrieve details of the mapped transaction fields;

wherein, upon acceptance of the user to retrieve the transaction details, the transaction details mapped to the transaction accepted fields are disclosed to the user so as to allow the user to assess the relevance of the mapped transaction fields;

wherein, if the user accepts the transaction mapped fields, then the system suggests suppliers with relevant details as catalogs to the user;

wherein, upon the user accepting any one such displayed catalog, the system captures the address and other relevant details of the supplier used for that transaction;

wherein, if the item tied to the supplier is categorized as a custom made item, then the system guides the user to a second guiding system;

wherein the system further transforms the web-based form into a customized web form depicting additional fields to capture user customizations based on user selected customization options;

wherein the system is operable to suggest a variety of customized items and prices corresponding to the customized options;

wherein, upon the user selecting at least one customized option, the customized web form is finalized and directs the user to a third guiding system for further processing.

In an aspect of this embodiment, the third guiding system comprises:

a procurement tool, a supplier information system tool, and a supplier performance system tool;

wherein the third guiding system is operable to provide information on the availability of contracted suppliers for a particular item to be purchased;

wherein the third guiding system is operable to provide information of approved suppliers for the particular item to be purchased and a ranking system to rank the suppliers based on a score determined from a supplier performance report that is present in the supplier performance system tool; and

a display system to display suppliers with their performance scores.

In an aspect of this embodiment, the decision rules include mapping of the item required to be searched and the web-based form based on the UNSPC Code.

In an aspect of this embodiment, the third guiding system further comprises a suggesting system that is adapted for suggesting the source of procurement based on the user provided information of a web-based form.

In an aspect of this embodiment, the suggesting system suggests the source of procurement by mapping the source based upon user configurable decision rules, wherein the suggested source includes manufacturer, wholesaler, and/or retailer.

In an aspect of this embodiment, the suggesting system is further adapted for suggesting the suppliers from which the particular item can be procured upon selection of the source of procurement by the user, based at least upon one or more pre-configured rules.

In an aspect of this embodiment, the pre-configured rules include mapping of UNSPC Category Code of the item with the suppliers corresponding to that category code present in the supplier information system tool.

In an aspect of this embodiment, another pre-configured rule includes historic transactions with the supplier of the particular item to be purchased.

In an aspect of this embodiment, supplier suggestions by the suggesting system includes contracted suppliers, preferred suppliers, and/or approved suppliers for the corresponding category of the item from the supplier information system tool.

In an aspect of this embodiment, the guided procurement system facilitates the user to suggest new vendors.

For example, the user could manage an element of the system and method for guided procurement on the handheld mobile device (e.g., cellular phone, smartphone, PDA, laptop computer, tablet computer, and/or any other like device that is selectively operable to communicate with the host computer system (or component thereof) through a wired and/or wireless connection) for which management needs to be done for.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The invention will now be described in relation to the accompanying drawings in which:

FIG. 1 illustrates a schematic of the work flow of a guided procurement system;

FIG. 2 illustrates a schematic of a web-based form generation of the guided procurement system; and

FIG. 3 illustrates a schematic of the suggestion creation system of a source of procurement and supplier of the item by the guided procurement system.

The same reference numerals refer to the same parts throughout the various Figures.

### DETAILED DESCRIPTION OF THE INVENTION

The following description of the preferred embodiment(s) is merely exemplary in nature and is in no way intended to limit the invention, or uses.

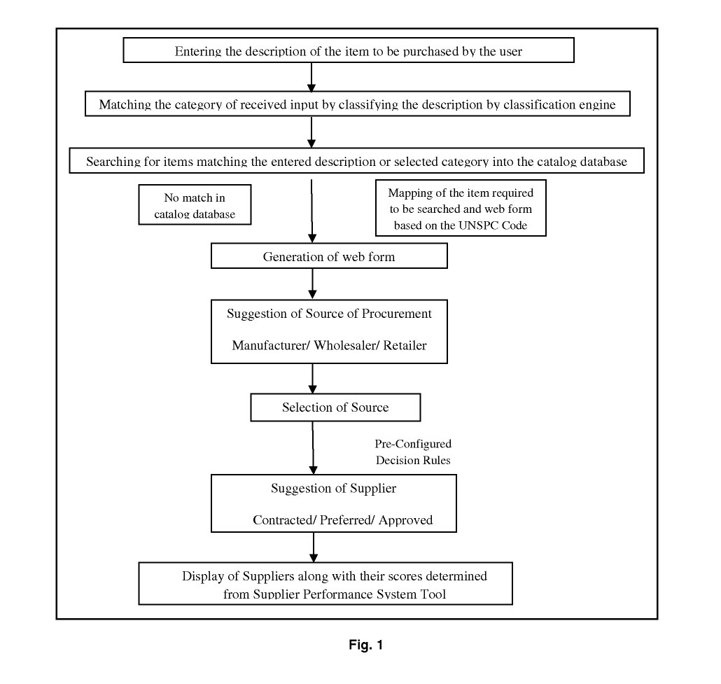

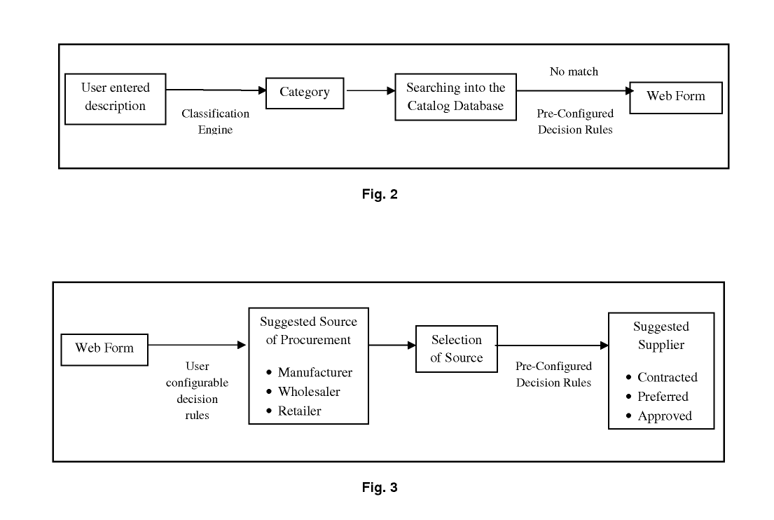

Referring to FIGS. 1-3, and according to an exemplary embodiment, a guided procurement system may include an integration of a procurement tool, a supplier information system tool, and a supplier performance system tool. The system may include a processor unit, and a computer readable medium storing instructions executable by the processor unit, including a first procurement guiding module, and a second procurement guiding module.

According to another exemplary embodiment, the first procurement guiding module of the guided procurement system may be adapted for guiding the requester during the procurement process, for example, when the item is not available in the catalog database, for example, the online catalog database.

By way of a non-limiting example, the first procurement guiding module may include an input system to enter the description of the item to be purchased by the user, a matching system to match the category of received input by classifying the description by classification engine, a searching system to search for items matching the entered description or selected category into the catalog database of the procurement tool, and/or a first guiding system to guide the user when no items are found in catalog database by providing a guiding link or button and then generating a web-based form based at least upon one or more pre-configured decision rule(s).

The decision rule of the first guiding system may include mapping of the item required to be searched and a web-based form based on the United Nations Standard Products and Services Code (“UNSPC”) Code.

According to yet another exemplary embodiment, the first procurement guiding module may further include a suggesting system that may be adapted for suggesting the source of procurement based on the user provided information key fields on the web-based form. This suggestion of the source of procurement by the suggesting system may be done by mapping the source based upon the user configurable decision rule(s), wherein the suggested source may be manufacturer, wholesaler, and/or retailer. The suggesting system may be further adapted for suggesting the supplier(s) from which the particular item can be procured upon selection of the source of procurement by user, for example, based at least upon one or more pre-configured rule(s), wherein the supplier suggestions may be contracted suppliers, preferred suppliers, and/or approved suppliers for the corresponding category of the item from the supplier information system tool. These pre-configured rule(s) may include, without limitation, mapping of the UNSPC Category Code of the item with the suppliers, corresponding to that category code present in the supplier information system tool. Another pre-configured rule(s) may include, without limitation, historic transactions with the supplier of the particular item to be purchased.

According to still another exemplary embodiment, the second procurement guiding module may be adapted for guiding the procurement team or the buyer for procurement from the right supplier, wherein the second procurement guiding module includes a second guiding system to provide information on the availability of contracted supplier(s) for the particular item to be purchased. The second guiding system may further provide information on approved supplier(s) for the particular item to be purchased, a ranking system to rank the suppliers based on their score determined from the supplier performance report which may be present in the supplier performance system tool, and/or a display system to display the suppliers with their performance scores.

By way of a non-limiting, the guided procurement system facilitates the user to suggest new vendors.

### Example

The user will enter a free-text description of the item to be procured in the common natural language that includes quantity, color, size, price, part number, etc. Based on this description, the classification engine will classify into UNSPC code and web-based form for the corresponding category of UNSPC code is displayed to user. Based on the user entered information of key fields on web form, a source of procurement will be suggested. If the user wants to buy pens, then based on the quantity of pens, the suggesting system will suggest whether he or she should buy from the manufacturer, retailer or wholesaler. Once the source is selected by the user, the suggesting system will further suggest suppliers for it. This suggestion will be based on mapping of the UNSPC code of the item with the suppliers corresponding to that category code present in the supplier information system tool and historic transactions with the supplier of that item. These suppliers will be displayed along with their scores determined from the supplier performance report present in the supplier performance system tool.

The guided procurement system of the present invention has following advantages: (1) it helps capture all relevant information pertaining to what the user needs, which avoids repeated back-and-forth with the procurement team, which is mostly offline; (2) correct classification of the requirement of the system ensures machine-based purchasing compliance by enforcing purchasing policies, budgets and approval workflows; (3) it drives maximum spend through preferred/contracted suppliers; and/or (4) it also facilitates the user to suggest new vendors.

By way of a non-limiting example, the user may provide a free text input description of the item to be purchased on the input/output device. For example, the user may provide a free text inputs on the mobile device for the items that the user wants to request to the procurement team for purchase.

Upon receiving the free text user input(s), there may be provided a first guiding system to guide the user when no items are found in the catalog database by providing a guiding link or button and then generating a guided web-based form based at least upon one or more pre-configured decision rules. So, if no items are found in the catalog database, then the user may be guided by the system by providing the guided web based form.

By way of a non-limiting example, a second guided system may be provided. The user may be required to fill up one or more key mandatory fields on the guided web based form. Upon the user filling up the required key fields in the web based form, the key fields may then be mapped with the fields present in the transaction history database to fetch all relevant transactions having those related key fields. For example, on the web based form, if the user provides as an input to the key fields “legal-attorney,” then the system may map these words with all relevant words present in the transaction database. This mapping may be based on an artificial intelligence trained system of heuristics and a knowledge base data. The system may suggest all the relevant transactions containing the terms “legal attorney,” “legal counsel,” “advocate,” “patent attorney” and many more transactions consisting of all such relevant inputs.

In the fetched transaction title, if the user views “patent attorney” and thinks that this could be the probable match for what the user is looking for, then the user may select that transaction line item and click on to it to retrieve the transaction. Upon selecting the retrieved transaction, the user will be able to view all the details pertaining to that transaction, like “patent attorney filed patent” and, if the user thinks that the transaction details are relevant, then the user may click “OK” for further processing. Now, if the user clicks “OK,” then all relevant catalogs connected to the transaction for “patent attorney filed patents” will be showcased to the user. The user may select one catalog from the transactional catalog database. The user, upon selecting one of the transactional catalogs, may capture all relevant fields of the transactional selected catalog to the guided web based form. Now, if the item so selected from the transactional catalog database is input into the guided web based form, depicts that the item so selected is a customized item, then the system will provide further options connected with such customization.

For example, suppose there is a catalog item called “T-shirts” that are available in four sizes. Because the price is the same for the regular size and one color, the user sees just one item. On adding the item to the cart, there may be a customization form that asks the user to pick the desired size and color in the web based form. Upon selecting the XXL size and the RAINBOW color, the system will capture the price for this description and will show a $15 price, instead the $10 price for a regular size and color T-shirt. So, this web based form may guide, or alert, the user that if he/she selects any other “rare” size/color combination, other than a regular, single color, then he/she will be required to pay a higher price. This may be depicted to the buyer before “freezing” or finalizing the purchase requisition, rather than the buyer coming to know these facts after the freezing of the purchase requisition, to which modification will be difficult.

In some applications, the present invention described above may be provided as elements of an integrated software system, in which the features may be provided as separate elements of a computer program. Some embodiments may be implemented, for example, using a computer-readable storage medium (e.g., non-transitory) or article which may store an instruction or a set of instructions that, if executed by a processor, may cause the processor to perform a method in accordance with the embodiments. Other applications of the present invention may be embodied as a hybrid system of dedicated hardware and software components. Moreover, not all of the features described above need be provided or need be provided as separate units. Additionally, it is noted that the arrangement of the features do not necessarily imply a particular order or sequence of events, nor are they intended to exclude other possibilities. For example, the features may occur in any order or substantially simultaneously with each other. Such implementation details are immaterial to the operation of the present invention unless otherwise noted above.

The exemplary methods and computer program instructions may be embodied on a computer readable storage medium (e.g., non-transitory) that may include any medium that can store information. Examples of a computer readable storage medium (e.g., non-transitory) include electronic circuits, semiconductor memory devices, ROM, flash memory, erasable ROM (EROM), floppy diskette, CD-ROM, optical disk, hard disk, fiber optic medium, or any electromagnetic or optical storage device. In addition, a server or database server may include computer readable media configured to store executable program instructions. The features of the embodiments of the present invention may be implemented in hardware, software, firmware, or a combination thereof and utilized in systems, subsystems, components or subcomponents thereof.

Furthermore, a software program embodying the features of the present invention may be used in conjunction with a computer device or system. Examples of a computing device or system may include, but are not limited to, an electronic book reading device, a computer workstation, a terminal computer, a server computer, a handheld device (e.g., a tablet computer, a personal digital assistant “PDA”, a mobile telephone, a Smartphone, etc.), a web appliance, a network router, a network switch, a network bridge, any machine capable of executing a sequence of instructions that specify an action to be taken by that machine, and any combinations thereof. In one example, a computing device may include and/or be included in, a kiosk.

The computer device or system may also include an input device. In one example, a user of the computer device or system may enter commands and/or other information into computer device or system via an input device. Examples of an input device may include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. The input device may be interfaced to bus via any of a variety of interfaces including, but not limited to, a serial interface, a parallel interface, a game port, a USB interface, a FIREWIRE interface, a direct interface to bus, and any combinations thereof. The input device may include a touch screen interface that may be a part of or separate from the display.

A user may also input commands and/or other information to the computer device or system via a storage device (e.g., a removable disk drive, a flash drive, etc.) and/or a network interface device. A network interface device, such as network interface device may be utilized for connecting the computer device or system to one or more of a variety of networks and/or one or more remote devices connected thereto. Examples of a network interface device may include, but are not limited to, a network interface card (e.g., a mobile network interface card, a LAN card), a modem, and any combination thereof. Examples of a network may include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software, etc.) may be communicated to and/or from the computer device or system via a network interface device.

The computer device or system may further include a video display adapter for communicating a displayable image to a display device, such as a display device. Examples of a display device may include, but are not limited to, a liquid crystal display (LCD), a cathode ray tube (CRT), a plasma display, a light emitting diode (LED) display, and any combinations thereof. In addition to a display device, the computer device or system may include one or more other peripheral output devices including, but not limited to, an audio speaker, a printer, and any combinations thereof. Such peripheral output devices may be connected to a bus via a peripheral interface. Examples of a peripheral interface may include, but are not limited to, a serial port, a USB connection, a FIREWIRE connection, a parallel connection, and any combinations thereof.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for a guided procurement, wherein there is an interconnection of at least one configurable and namable business process element, comprising:
a host computer system;
at least one database component operably associated with the host computer system;
a communication interface for accessing the host computer system from a plurality of remote input/output devices to manage guided procurement, wherein the business process element includes:
a system for permitting a user to provide a free text input description of an item to be purchased on the input/output device;
a first guiding system operable to guide the user, when no items are found in a catalog database, to a guiding link or button and then generate a guided web-based form based at least upon one or more pre-configured decision rules;
wherein the first guiding system adapted for inputting information of one or more key fields on the guided web-based form, mapping the key fields input with one or more fields present in a transaction database, suggesting matched transaction fields to the key fields and providing the user an option to retrieve details of the mapped transaction fields;
wherein, upon acceptance of the user to retrieve the transaction details, the transaction details mapped to the transaction accepted fields are disclosed to the user so as to allow the user to assess the relevance of the mapped transaction fields;
wherein, if the user accepts the transaction mapped fields, then the system suggests suppliers with relevant details as catalogs to the user;
wherein, upon the user accepting any one such displayed catalog, the system captures the address and other relevant details of the supplier used for that transaction;
wherein, if the item tied to the supplier is categorized as a custom made item, then the system guides the user to a second guiding system;
wherein the system further transforms the web-based form into a customized web form depicting additional fields to capture user customizations based on user selected customization options;
wherein the system is operable to suggest a variety of customized items and prices corresponding to the customized options;
wherein, upon the user selecting at least one customized option, the customized web form is finalized and directs the user to a third guiding system for further processing.

2. The system as claimed in claim 1, wherein the third guiding system comprises:
a procurement tool, a supplier information system tool, and a supplier performance system tool;
wherein the third guiding system is operable to provide information on the availability of contracted suppliers for a particular item to be purchased;
wherein the third guiding system is operable to provide information of approved suppliers for the particular item to be purchased and a ranking system to rank the suppliers based on a score determined from a supplier performance report that is present in the supplier performance system tool; and
a display system to display suppliers with their performance scores.

3. The system as claimed in claim 2, wherein the decision rules include mapping of the item required to be searched and the web-based form based on the UNSPC Code.

4. The system as claimed in claim 2, wherein the third guiding system further comprises a suggesting system that is adapted for suggesting the source of procurement based on the user provided information of a web-based form.

5. The system as claimed in claim 4, wherein the suggesting system suggests the source of procurement by mapping the source based upon user configurable decision rules, wherein the suggested source includes manufacturer, wholesaler, and/or retailer.

6. The system as claimed in claim 4, wherein the suggesting system is further adapted for suggesting the suppliers from which the particular item can be procured upon selection of the source of procurement by the user, based at least upon one or more pre-configured rules.

7. The system as claimed in claim 6, wherein the pre-configured rules include mapping of UNSPC Category Code of the item with the suppliers corresponding to that category code present in the supplier information system tool.

8. The system as claimed in claim 6, wherein another pre-configured rule includes historic transactions with the supplier of the particular item to be purchased.

9. The system as claimed in claim 4, wherein supplier suggestions by the suggesting system includes contracted suppliers, preferred suppliers, and/or approved suppliers for the corresponding category of the item from the supplier information system tool.

10. The system as claimed in claim 1, wherein the guided procurement system facilitates the user to suggest new vendors.
